(19) United States
(12) Patent Application Publication
(10) Pub. No.: US 2026/0334627 A1
(43) Pub. Date: Oct. 29, 2026

(54) INSOLE AND INSOLE MANUFACTURING METHOD

(71) Applicant: ASAN S&TECH CO.,LTD, Busan (KR)

(72) Inventors: Tae Gu JEON, Busan (KR); Sang Seok OH, Gimhae-si, Gyeongsangnam-do (KR); Young Jun KIM, Busan (KR)

(21) Appl. No.: 19/114,455

(22) PCT Filed: Oct. 12, 2022
(86) PCT No.: PCT/KR2022/015353

§ 371 Date: Apr. 15, 2025

(30) Foreign Application Priority Data
Sep. 23, 2022 (KR) 10-2022-0120464

(51) Int. Cl. A43B 17/00; A43B 7/02

(52) U.S. Cl. CPC A43B 17/003; A43B 7/02

(57) ABSTRACT

The present invention relates to an insole and an insole manufacturing method and, more specifically, to an insole having a thermally conductive sheet capable of maintaining thermal conductance even if an expanded graphite sheet used for the insole is broken, and an insole manufacturing method. An insole according to the present invention comprises a thermally conductive sheet means, an upper finish portion, and a lower finish portion. The thermally conductive sheet means comprises an expanded graphite sheet portion obtained by thermally processing graphite such that same is expanded and becomes a sheet, and a copper plate portion coupled to the upper and lower surfaces of the expanded graphite sheet portion such that the thermal conductance of the expanded graphite sheet portion can be diffused. Multiple through-holes are formed at a predetermined interval from each other so as to extend from the upper surface to the lower surface of the thermally conductive sheet means. The upper finish portion is coupled to the upper portion of the thermally conductive sheet means. The lower finish portion is injection-blown so as to surround the lower portion of the thermally conductive sheet means and is coupled to the upper finish portion. According to the present invention, a copper foil is coupled to both surfaces of the expanded graphite sheet. In this case, heat can be transferred through the copper foil even if the expanded graphite sheet is broken by an external force, thereby maintaining the thermal conductivity of the thermally conductive sheet. In addition, according to the present invention, the lower finish portion is injection-blown so as to surround the lower portion of the thermally conductive sheet and is coupled to the upper finish portion through a through-hole of the thermally conductive sheet. In this case, the lower finish portion inserted into the through-hole is coupled to the upper finish portion such that, even if the expanded graphite sheet is deformed or broken, the upper and lower finish portions can be prevented from detaching from the thermally conductive sheet. Therefore, defective products can be reduced.

### TECHNICAL FIELD

The present invention relates to an insole and an insole manufacturing method, and more specifically, to an insole having a thermally conductive sheet capable of maintaining thermal conductivity even when an expanded graphite sheet used for the insole is damaged, and an insole manufacturing method.

### BACKGROUND ART

In general, expanded graphite sheets are made by treating graphite, such as natural graphite, pyrolytic graphite, and Kish graphite, with a mixed solution of sulfuric acid, nitric acid, etc., washing and drying the graphite, and then expanding the graphite at high temperature using a heating device and rolling the graphite into sheets using a roll.

Since expanded graphite sheets have a higher thermal conductivity in a plane direction than in a thickness direction, the expanded graphite sheets are used as materials for transferring heat from a heat source to other places. For example, when applied to a shoe insole, expanded graphite sheets can be cut to an appropriate size and then bonded with finishing materials such as cloth, ethylene vinyl acetate (EVA) sponge, shock absorbers, etc. on the top and bottom of the shoe insole to serve as a heating sheet.

However, in the case of a heating sheet using the above-mentioned expanded graphite sheet, the expanded graphite sheet was deformed or damaged by an external force such as a pedestrian's weight or continuous impact when walking due to the brittle nature of the expanded graphite sheet. Accordingly, not only the thermal conductivity of the expanded graphite sheet is degraded, but also the adhesive surface of the expanded graphite sheet is separated to separate the upper finishing material and the lower finishing material and the expanded graphite sheet comes out of the separated part, and thus there was a problem that caused the product to lose its functionality.

Korean Patent Registration No. KR 10-0958444 (Registration Date: May 10, 2010)

### DETAILED DESCRIPTION

### Technical Problem

The present invention is devised to solve the above problems. The present invention is directed to providing an insole having a thermally conductive sheet capable of maintaining thermal conductivity even when an expanded graphite sheet used for the insole is damaged, and an insole manufacturing method.

### Technical Solution

An insole according to the present invention includes a thermally conductive sheet unit, an upper finishing portion, and a lower finishing portion. The thermally conductive sheet unit includes an expanded graphite sheet portion made by expanding graphite by heat treatment and then forming the graphite into a sheet, copper foil portions bonded to upper and lower surfaces of the expanded graphite sheet portion to diffuse the heat conduction of the expanded graphite sheet portion, and a plurality of through holes formed at regular intervals and passing through from an upper surface to a lower surface of the thermally conductive sheet unit. The upper finishing portion is bonded to an upper portion of the thermally conductive sheet unit. The lower finishing portion is foam-injection-molded to surround a lower portion of the thermally conductive sheet unit and is combined with the upper finishing portion.

In addition, in the insole, a thickness of the expanded graphite sheet portion may be 400 μm to 500 μm, and a thickness of the copper plate may be 6 μm to 8 μm.

An insole manufacturing method according to the present invention includes an expanded graphite sheet preparation operation, a copper foil preparation operation, a copper foil bonding operation, a thermally conductive sheet manufacturing operation, an upper finishing portion bonding operation, a molding operation, and a completion operation. In the expanded graphite sheet preparation operation, an expanded graphite sheet portion made by expanding graphite by heat treatment and then forming the graphite into a sheet is prepared. In the copper foil preparation operation, copper foil portions that diffuse heat conduction of the expanded graphite sheet portion are prepared. In the copper foil bonding operation, the copper foil portions are bonded to an upper surface and a lower surface of the expanded graphite sheet portion using an adhesive. In the thermally conductive sheet manufacturing operation, a plurality of through holes spaced at regular intervals from each other and passing through from the upper surface to the lower surface of the expanded graphite sheet portion to which the copper foil portion is bonded in the copper foil bonding operation are formed, and the thermally conductive sheet unit is manufactured by performing cutting along an insole shape. In the upper finishing portion bonding operation, an upper finishing portion is bonded to an upper portion of the thermally conductive sheet unit manufactured in the insole shape using an adhesive. In the molding operation, a lower finishing portion is combined with the upper finishing portion and molded into an insole shape by foaming the lower finishing portion to surround a lower portion of the thermally conductive sheet unit so that the thermally conductive sheet unit is not exposed. In the completion operation, the upper finishing portion bonded to the upper portion of the thermally conductive sheet unit is cut along the insole shape to complete an insole.

### Advantages of Invention

According to the present invention, copper foil is bonded to both sides of the expanded graphite sheet. In this case, even when the expanded graphite sheet is damaged by an external force, heat can be transferred through the copper foil, thus maintaining the thermal conductivity of the thermally conductive sheet.

In addition, according to the present invention, a lower finishing portion is foam-injection-molded so as to surround a lower portion of the thermally conductive sheet and is combined with an upper finishing portion through a through hole of the thermally conductive sheet. In this case, the lower finishing portion inserted into the through hole is combined with the upper finishing portion such that, even when the expanded graphite sheet is deformed or damaged, the upper and lower finishing portions can be prevented from being separated from the thermally conductive sheet. Therefore, the number of product defects can be reduced.

### DESCRIPTION OF DRAWINGS

FIG. 1 is a conceptual diagram of a thermally conductive sheet unit of an insole according to the present invention.

FIG. 2 is a cross-sectional view of one embodiment of the insole according to the present invention.

FIG. 3 is a flowchart of a method of manufacturing the insole according to the present invention.

FIG. 4 is a schematic flowchart illustrating the method of manufacturing the insole of FIG. 3.

10: thermally conductive sheet unit 11: expanded graphite sheet portion
13: copper foil portion 15: through hole
20: upper finishing portion 30: lower finishing portion
G: adhesive

### BEST MODES OF THE INVENTION

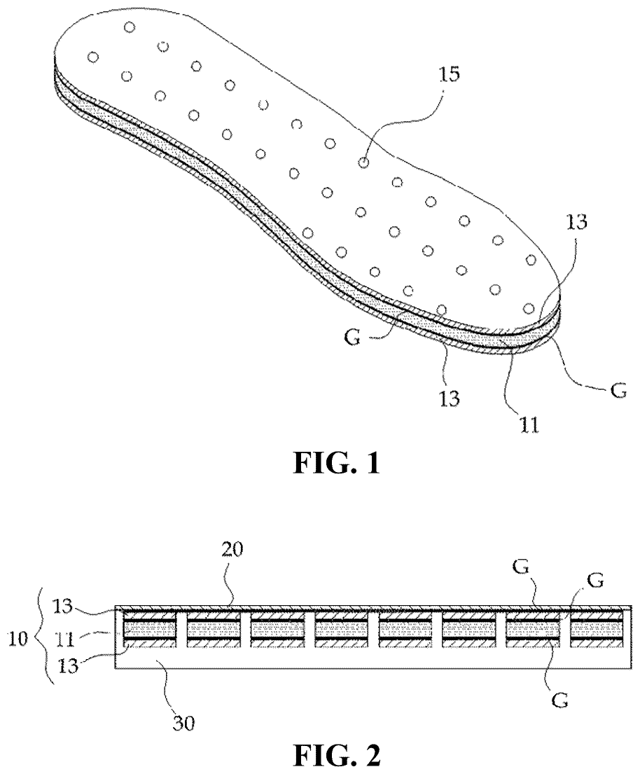

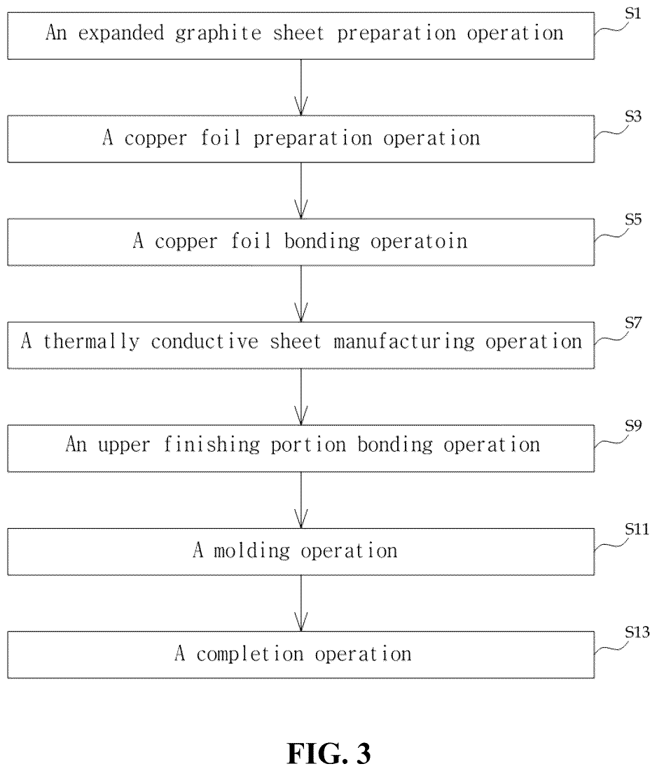

Referring to FIGS. 1 to 4, embodiments of an insole and an insole manufacturing method according to the present invention will be described.

First, the insole according to the present invention includes a thermally conductive sheet unit 10, an upper finishing portion 20, and a lower finishing portion 30.

The thermally conductive sheet unit 10 includes an expanded graphite sheet portion 11 and copper foil portions 13, and through holes 15 are formed therein.

The expanded graphite sheet portion 11 is made by expanding graphite by heat treatment and then forming the graphite into a sheet. Here, the thickness of the expanded graphite sheet portion 11 is formed to be approximately 400 μm to 500 μm. In the case of the expanded graphite sheet portion 11, there is an advantage of high thermal conductivity and thus high heat retention, but there is a disadvantage that it is easily broken.

The copper foil portion 13 serve to protect the expanded graphite sheet portion 11 and maintain thermal conductivity even when the expanded graphite sheet portion 11 is damaged. To this end, the copper foil portion 13 is bonded to each of an upper surface and a lower surface of the expanded graphite sheet portion 11 by an adhesive G. Therefore, since the copper foil portion 13 has high thermal conductivity, even when the expanded graphite sheet portion 11 is damaged, heat may be transferred through the copper foil portion 13, and thus, the thermal conductivity of the thermally conductive sheet unit 10 may be maintained. Here, the thickness of each copper foil portion 13 is formed to be 6 μm to 8 μm.

The through holes 15 pass through from an upper surface to a lower surface of the thermally conductive sheet unit 10, and a plurality of through holes 15 are formed to be spaced apart from each other at regular intervals.

The upper finishing portion 20 is bonded to an upper portion of the thermally conductive sheet unit 10 by the adhesive G. Here, the upper finishing portion 20 may be made of various materials, such as cloth, leather, fiber, and the like, depending on the needs of the user.

The lower finishing portion 30 is foam-injection-molded to surround a lower portion of the thermally conductive sheet unit 10 and combined with the upper finishing portion 20. Here, the lower finishing portion 30 may be made of PU foam, EVA foam, plastic foam, or the like and is formed thicker than the upper finishing portion 20 to serve as a cushion. Since the lower finishing portion 30 is foam-injection-molded and combined with the upper finishing portion 20 through the through hole 15, it is possible to prevent the upper finishing portion 20 and the lower finishing portion 30 from being separated from the thermally conductive sheet unit 10 even when the expanded graphite sheet portion 11 is deformed or damaged by an external force. Thus, the number of product defects can be reduced.

Hereinafter, an insole manufacturing method according to the present invention is described.

The insole manufacturing method according to the present invention includes an expanded graphite sheet preparation operation S1, a copper foil preparation operation S3, a copper foil bonding operation S5, a thermally conductive sheet manufacturing operation S7, an upper finishing portion bonding operation S9, a molding operation S11, and a completion operation S13.

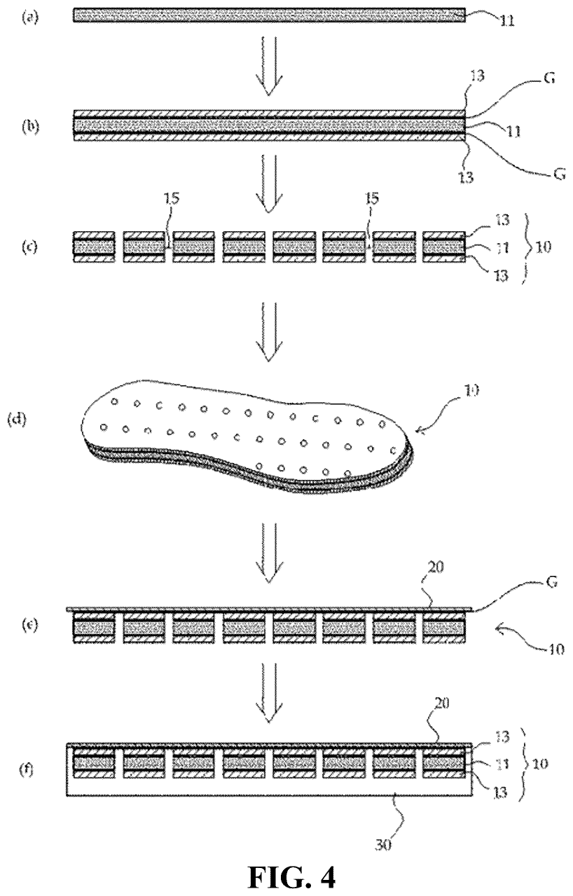

In the expanded graphite sheet preparation operation S1, an expanded graphite sheet portion made by expanding graphite by heat treatment and then formed the graphite into a sheet is prepared as shown in FIG. 4A.

In the copper foil preparation operation S3, a copper foil portion 13 having high thermal conductivity is prepared to protect the expanded graphite sheet portion 11 and maintain thermal conductivity even when the expanded graphite sheet portion 11 is damaged.

In the copper foil bonding operation S5, the copper foil portion 13 prepared in the copper foil preparation operation S3 is bonded to each of an upper surface and a lower surface of the expanded graphite sheet portion 11 prepared in the expanded graphite sheet preparation operation S1 using an adhesive G as shown in FIG. 4B.

In the thermally conductive sheet manufacturing operation S7, as shown in FIG. 4C, through holes 15 are formed to pass through from the upper surface to the lower surface of the expanded graphite sheet portion 11 to which the copper foil portion 13 is bonded in the copper foil bonding operation S5, and the thermally conductive sheet unit 10 is manufactured by performing cutting along the shape of an insole as shown in FIG. 4D. In this case, the plurality of through holes 15 are formed to be spaced apart from each other at regular intervals.

In the upper finishing portion bonding operation S9, as shown in FIG. 4E, an upper finishing portion 20 is bonded to an upper portion of the thermally conductive sheet unit 10 manufactured in the insole shape in the thermally conductive sheet manufacturing operation S7 using the adhesive G.

In the molding operation S11, as shown in FIG. 4F, a lower finishing portion 30 is molded into an insole shape by foaming the lower finishing portion 30 on a lower portion of the thermally conductive sheet unit 10 to which the upper finishing portion 20 is bonded in the upper finishing portion bonding operation S9. At this time, the lower finishing portion 30 is combined with the upper finishing portion 20 and formed to surround the lower portion of the thermally conductive sheet unit 10 so that the thermally conductive sheet unit 10 is not exposed. In this embodiment, after putting the thermally conductive sheet unit 10 combined with the upper finishing portion 20 into a mold, the material of the lower finishing portion 30 is injected and foamed toward the lower portion of the thermally conductive sheet unit 10 to combine the thermally conductive sheet unit 10 with the lower finishing portion 30. At this time, the lower finishing portion 30 is not only combined with the thermally conductive sheet unit 10, but a portion of the lower finishing portion enters the through hole 15 of the thermally conductive sheet unit 10 and is combined with the upper finishing portion 20. In this case, even when the expanded graphite sheet portion 11 of the thermally conductive sheet unit 10 is deformed or damaged by an external force, the upper finishing portion 20 and the lower finishing portion 30 may be prevented from being separated from the thermally conductive sheet unit 10. Thus, the number of product defects can be reduced.

In the completion operation S13, the upper finishing portion 20 bonded to the upper portion of the thermally conductive sheet unit 10 is cut along the insole shape to complete the insole. In the present embodiment, after the thermally conductive sheet unit 10 combined with the lower finishing portion 30 molded in the shape of the insole in the molding operation S11 is taken out of the mold, the upper finishing portion 20 bonded to the upper portion of the thermally conductive sheet unit 10 is cut along a shape the same as the insole shape of the thermally conductive sheet unit 10.

In the related art, when a heating sheet using an expanded graphite sheet is applied to a shoe insole, the expanded graphite sheet is deformed or damaged by an external force such as a pedestrian's weight or continuous impact when walking due to the brittle nature of expanded graphite. As a result, not only does the thermal conductivity of the expanded graphite sheet deteriorate, but also the adhesive surface of the expanded graphite sheet falls off, the upper and lower finishing materials are separated, and the expanded graphite sheet comes out through the separated area, causing the product to lose its function. On the other hand, in the case of the present embodiment, the copper foil portions 13 are bonded to both sides of the expanded graphite sheet portion 11. In this case, even when the expanded graphite sheet portion 11 is damaged by an external force, heat may be transferred through the copper foil portion 13, thereby maintaining the thermal conductivity of the thermally conductive sheet unit 10. Furthermore, in the case of the present embodiment, the lower finishing portion 30 is foam-injection-molded to surround the lower portion of the thermally conductive sheet unit 10 and is combined with the upper finishing portion 20 through the through hole 15 of the thermally conductive sheet unit 10. In this case, since the lower finishing portion 30 inserted into the through hole 15 is combined with the upper finishing portion 20, it is possible to prevent the upper finishing portion 20 and the lower finishing portion 30 from being separated from the thermally conductive sheet unit 10 even when the expanded graphite sheet portion 11 is deformed or damaged. Thus, the number of product defects can be reduced.

1. An insole comprising:
a thermally conductive sheet unit which includes an expanded graphite sheet portion made by expanding graphite by heat treatment and then forming the graphite into a sheet, copper foil portions bonded to upper and lower surfaces of the expanded graphite sheet portion to diffuse heat conduction of the expanded graphite sheet portion, and a plurality of through holes spaced at regular intervals from each other and passing through from an upper surface to a lower surface of the thermally conductive sheet unit;
an upper finishing portion bonded to an upper portion of the thermally conductive sheet unit; and
a lower finishing portion which is foam-injection-molded to surround a lower portion of the thermally conductive sheet unit and is combined with the upper finishing portion.

2. The insole of claim 1, wherein a thickness of the expanded graphite sheet portion is 400 μm to 500 μm, and a thickness of the copper foil portion is 6 μm to 8 μm.

3. An insole manufacturing method comprising:
an expanded graphite sheet preparation operation of preparing an expanded graphite sheet portion made by expanding graphite by heat treatment and then forming the graphite into a sheet;
a copper foil preparation operation of preparing copper foil portions to diffuse heat conduction of the expanded graphite sheet portion;
a copper foil bonding operation of bonding the copper foil portions to an upper surface and a lower surface of the expanded graphite sheet portion using an adhesive;
a thermally conductive sheet manufacturing operation of forming a plurality of through holes spaced at regular intervals from each other and passing through from the upper surface to the lower surface of the expanded graphite sheet portion to which the copper foil portions are bonded in the copper foil bonding operation, and manufacturing a thermally conductive sheet unit by performing cutting along an insole shape;
an upper finishing portion bonding operation of bonding an upper finishing portion to an upper portion of the thermally conductive sheet unit manufactured in the insole shape using an adhesive;
a molding operation of foaming a lower finishing portion combined with the upper finishing portion and molding the lower finishing portion into an insole shape to surround a lower portion of the thermally conductive sheet unit so that the thermally conductive sheet unit is not exposed; and
a completion operation of cutting the upper finishing portion bonded to the upper portion of the thermally conductive sheet unit along the insole shape to complete an insole.
